(19) United States
(12) Patent Application Publication
(10) Pub. No.: US 2008/0078664 A1
(43) Pub. Date: Apr. 3, 2008

(54) Dielectric Housing Having a Ventilation Shaft

(75) Inventors: Matthias Schmidt, Berlin (DE); Ralf-Reiner Volkmar, Oldenburg i.H. (DE)

Correspondence Address: LERNER GREENBERG STEMER LLP, P O BOX 2480, HOLLYWOOD, FL, 33022-2480, US

(73) Assignee: Siemens Aktiengesellschaft

(21) Appl. No.: 11/663,903

(22) PCT Filed: Sep. 13, 2005
(86) PCT No.: PCT/EP05/54544

§ 371 Date: Mar. 26, 2007

(30) Foreign Application Priority Data
Sep. 24, 2004 (DE) 10 2004 047 260.2

(51) Int. Cl. H01H 9/52

(52) U.S. Cl. 200/289

(57) ABSTRACT

An insulating material housing has a holding section, which is designed for holding a switching tube and which is fitted with an input connecting piece, and a drive section, which connects to the holding section in a longitudinal direction, has a drive opening for introducing a drive movement into the switching tube, and which is fitted with an output connecting piece. A ventilation shaft is provided that communicates with an inner space of the drive section. The object is to provide an insulating material housing of this general type with which, even in the event of large currents, a sufficiently high cooling capacity is provided. To this end, the ventilation shaft surrounds the holding section in the shape of a collar.

The invention relates to a dielectric housing having a holding section which is designed to hold a switching tube and is equipped with an input connecting piece, and having a drive section which is adjacent to the holding section in a longitudinal direction, has a drive opening for initiation of a drive movement in the switching tube and is equipped with an outgoer connecting piece, with a ventilation shaft -which communicates with an internal area of the drive section being provided.

The invention also relates to a solid-insulated switch pole having a dielectric housing, in which a switching tube is arranged.

A dielectric housing such as this and a solid-insulated switch pole such as this are already known from Chinese utility model CNZL00246088.2. A switching tube whose stationary fixed contact is screwed to an input connecting piece with which contact can be made from the outside, that is to say from outside the dielectric housing, is encapsulated in the dielectric housing disclosed there. On its side facing away from the input connecting piece, the switching tube has a metallic end cap, through which a switching rod which is guided such that it can move passes. The switching rod is connected via a flexible strip to an outgoer connecting piece, with which contact can likewise be made from the outside. In order to introduce a drive movement to the switching rod, the dielectric housing has an opening, through which a drive rod extends. The drive rod is provided in order to introduce a drive movement of a drive unit into the switching rod. In the connected state, an electric current flows via the input connecting piece, the contacts of the switching tube, the switching rod, the flexible strip and the outgoer connecting piece. A dissipative energy loss, which is dependent on the magnitude of the current, occurs in the form of heat owing to the increased resistance, in particular at the flexible strip. A ventilation shaft in the form of a channel is provided in order to dissipate this heat, and communicates via an inlet opening with the interior of the dielectric housing. The heated air, which rises upwards, enters the ventilation shaft via the inlet opening, and is finally emitted to the atmosphere. The heat is thus carried out of the interior of the dielectric housing, with cold ambient air then being sucked through the drive opening of the dielectric housing.

The already known dielectric housing has the disadvantage that the cooling power which is produced by the ventilation shaft that is in the form of a channel is inadequate, particularly for relatively high electric currents.

The object of the invention is therefore to provide a solid-insulated switch pole and a dielectric housing of the type mentioned initially, by means of which sufficiently high cooling power is provided even for high electric currents.

The invention achieves this object by the ventilation shaft surrounding the holding section in the form of a collar.

According to the invention, the convection is no longer produced by a narrow cooling channel, as in the prior art. In fact a cooling shaft in the form of a collar is provided, which surrounds a wide area of the holding section, in which the switching tube is arranged. The ventilation shaft can surround the holding section completely, or only partially. However, the important factor is the fact that the ventilation shaft surrounding the holding section results in a considerably higher cooling power than in the case of the prior art. In this case, it is, of course, possible for reinforcing ribs to be arranged in the ventilation shaft, which are either gas-impermeable, or else may have gas-permeable passage areas. The reinforcing ribs are used to provide mechanical robustness for the ventilation shaft.

In a cross-section view, the two narrow boundary walls of the ventilation shaft advantageously cover an angle of at least 40 degrees with respect to the center point of the holding section.

In one preferred exemplary embodiment, the ventilation shaft tapers in the longitudinal direction towards its end remote from the drive section. The tapering of the ventilation shaft results in the formation of a nozzle section at the outlet end of the ventilation shaft. The flow velocity of the air flow through the ventilation shaft is greater in the nozzle area than at a larger intake opening of the ventilation shaft, via which the ventilation shaft communicates with the drive section. This results in a chimney effect, thus increasing the cooling power of the dielectric housing even further.

The holding section is advantageously tubular and the drive section is in the form of a truncated cone, with the internal diameter of the holding section being greater than the internal diameter of the drive section. The holding section is expediently matched to the dimensions of the switching tube which is intended to be mounted in the dielectric housing. In order to avoid air enclosures between the switching tube and the dielectric housing, elastic cushioning is normally provided which, furthermore, compensates for different thermal expansions when the switching tube is at relatively high temperatures, and helps to avoid the formation of cracks in the dielectric housing. The truncated-conical configuration of the drive section, which is arranged under the holding section, assists the chimney effect, which is created by the ventilation shaft. The cooling power is thus increased even further.

According to one expedient further development relating to this, the boundary wall of the ventilation shaft continues the truncated-conical external contour of the drive section, continuously, and without any steps. This results not only in the chimney effect but, at the same time, also in the dielectric housing being as compact as possible.

The holding section and the drive section are expediently connected to one another by means of a transition shoulder. In this case, the holding section and the drive section are integrally formed on one another, and are formed integrally, such that the dielectric housing can be produced using a casting process.

The input connecting piece is advantageously connected to a heat sink, with the ventilation shaft being designed such that any air flow which emerges from the ventilation shaft is directed at the heat sink. If the solid-insulated switch pole which is formed by the dielectric housing and the switching tube is designed for relatively high currents it is advantageous for further heat dissipation to connect the input connecting piece thermally conductively to a heat sink, so that the surface of the thermally conductive metallic material on which a high heat exchange rate with the surrounding air occurs is enlarged. The cooling power is considerably increased by directing the air flow up the heat sink, so that even higher electric currents can be controlled.

Expedient refinements and advantages are the subject matter of the following description, with reference to the figures of the drawing, in which components which have the same effect are provided with the same reference symbols, and in which:

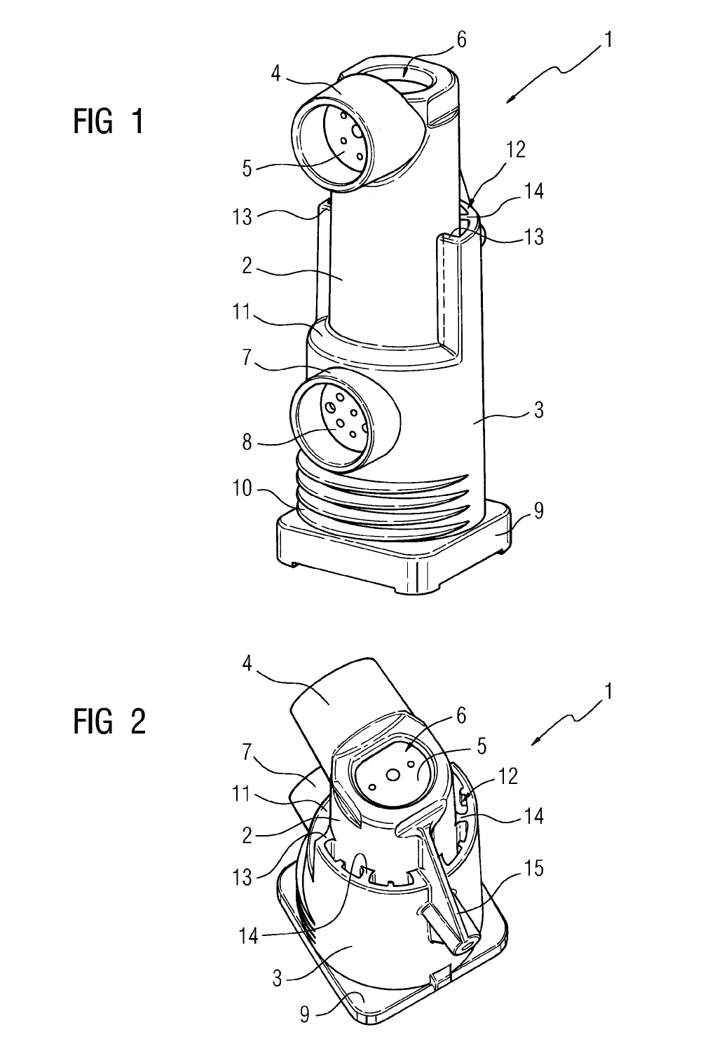

FIG. 1 shows a perspective illustration of one exemplary embodiment of the dielectric housing according to the invention,

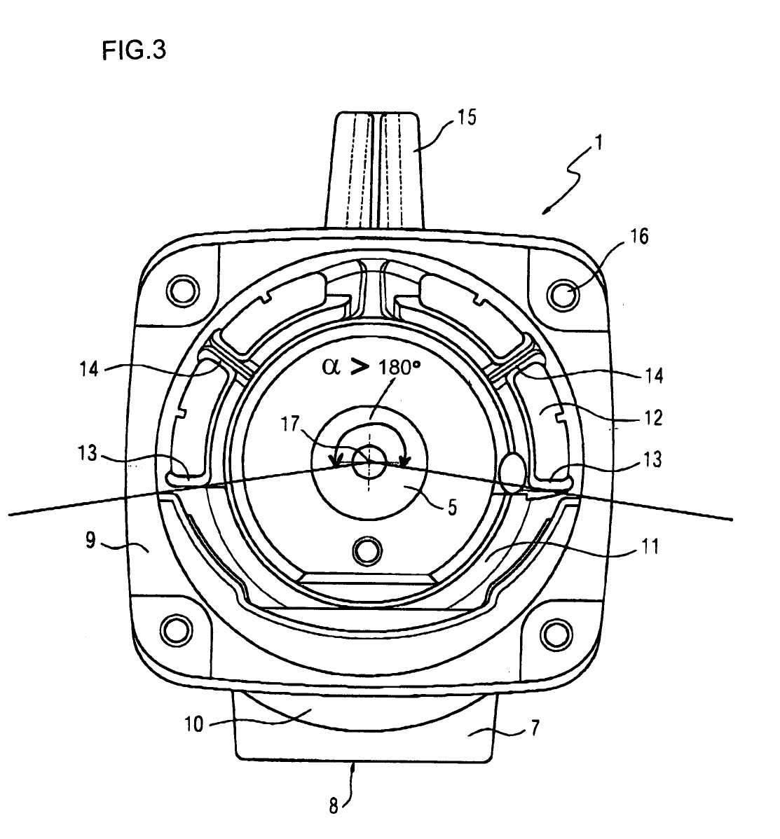

FIG. 2 shows the dielectric housing shown in FIG. 1, in a perspective plan view from above, and

FIG. 3 shows a plan view of the dielectric housing from underneath, thus showing the interior of the housing.

FIG. 1 shows one exemplary embodiment of the dielectric housing 1 according to the invention, in the form of a perspective illustration. The dielectric housing 1 has an essentially hollow-cylindrical holding section 2, and a truncated-conical drive section 3, which is adjacent to the holding section in a longitudinal direction and has an internal diameter which is larger than that of the holding section 2. A holding sleeve 4, in which an input connecting piece 5 composed of copper is encapsulated, is formed at the upper end of the holding section 2. In order to attach a vacuum interrupter tube, which is not illustrated in the figures, a mounting opening 6 is provided behind the holding sleeve 4, through which the vacuum interrupter tube can be screwed to the input connecting piece 5.

A holding sleeve 7 is likewise integrally formed on the drive section 3, and an outgoer connecting piece 8 is encapsulated in it. The retention as well as the electrical connection of a vacuum interrupter tube to the input connecting piece 5 or to the outgoer connecting piece 8 result in a solid-insulated switch pole. The input connecting piece 5 is intended for connection to a high-voltage line, which is at a voltage of 10 to 50 KV with respect to the ground potential. When the vacuum interrupter tube is switched on, the outgoer connecting piece is also at the high-voltage potential. External ribs 10 are used to lengthen the creepage distance between an end piece 9, which is at ground potential, and the dielectric housing 1.

The holding section 2 merges in places over a transition shoulder 11 into the drive section 3. In contrast, a ventilation shaft 12 can be seen in the rear part of the dielectric housing 1, and its inlet opening is formed in the transition area between the drive section 3 and the holding section 4. In this case, the external contour of the drive section 3 is continued without any discontinuity by means of the circumferentially outer boundary surface of the ventilation shaft 12, so that transition shoulders 11 are avoided in the area of the ventilation shaft 12. In other words, the boundary wall of the ventilation shaft 12 continues the external contour of the drive section 3 continuously and without any steps. The ventilation shaft 12 surrounds more than half of the cylindrical holding section 3, with holding rods 14 being provided for mechanical robustness of the ventilation shaft 12.

FIG. 2 shows the dielectric housing from FIG. 1, in the form of a perspective illustration from above. As can be seen, the input connecting piece 5 extends beyond the mounting opening 6, thus allowing subsequent connection of the vacuum interrupter tube by a screwing action. An attachment rib 15 can also be seen, which is intended to provide robustness for the dielectric housing 1 or the solid-insulated switch pole when this is assembled with further switch poles arranged adjacent to it to form a switch. In this case, each switch pole is intended to switch one phase of a three-phase power supply system.

FIG. 3 shows the interior of the dielectric housing 1 in a plan view of the underneath of the dielectric housing 1. As can seen, the dielectric housing 1 is firmly screwed in the end piece 9 through holes 16. As can also be seen, the transition shoulder 11 is formed in the front area, while the ventilation shaft 12 extends effectively through a cutout in the transition shoulder 11 in the upper area. The two narrow faces 13 of the ventilation shaft 12 cover an angle of more than 180 degrees with respect to a center point 15 of the holding section 2. As can also be seen, the ventilation shaft 12 tapers towards its outlet opening remote from the end piece 9, thus making it possible to produce a chimney effect, which increases the cooling power. Once the vacuum interrupter tube has been installed in the holding section 2, heat is produced in the interior of the drive section 3, in particular at the level of the outgoer connecting piece 8, that is to say underneath the intake opening of the ventilation shaft 12. This heat is produced in particular at a moving contact connection, which provides the electrical link between the switching rod (which is guided such that it can move) of the vacuum interrupter tube and the stationary outgoer connecting piece. By way of example, a moving contact connection such as this has one or more flexible strips, a sliding contact, a rolling contact or the like. The increased amount of heat developed at the moving contact connection is a result of the increased electrical contact losses. The arrangement of the moving contact connection precisely underneath the intake opening of the ventilation shaft 12 allows the rising heat to enter the ventilation shaft directly, thus considerably increasing the cooling power. The invention avoids labyrinth-like flow paths of the air, as in the prior art.

1-8. (canceled)

9. A dielectric housing, comprising:
a holding section configured to hold a switching tube, said holding section including an input connecting piece;
a drive section adjacent said holding section in a longitudinal direction, said drive section having a drive opening for injecting a drive movement into said switching tube and said drive section including an output connecting piece; and
a ventilation shaft formed as a collar surrounding said holding section and communicating with an internal area of said drive section.

10. The dielectric housing according to claim 9, wherein said ventilation shaft has two narrow boundary walls, and said narrow boundary walls, in a cross-sectional view, cover an angle of at least 40 degrees with respect to a center point of said holding section.

11. The dielectric housing according to claim 9, wherein said ventilation shaft tapers in a longitudinal direction towards an end remote from said drive section.

12. The dielectric housing according to claim 9, wherein said holding section is substantially tubular and said drive section is in a form of a truncated cone, said holding section having an inner diameter smaller than an inner diameter of said drive section.

13. The dielectric housing according to claim 12, wherein said ventilation shaft has a boundary wall continuing the truncated-conical external contour of said drive section, substantially continuously and without any steps.

14. The dielectric housing according to claim 9, which comprises a transition shoulder at least partially connecting said holding section and said drive section.

15. The dielectric housing according to claim 9, wherein said input connecting piece is connected to a heat sink, and said ventilation shaft is configured such that air flow emerging therefrom is directed at the heat sink.

16. A solid-insulated switch pole, comprising a dielectric housing according to claim 9, and a switching tube disposed in said housing.
